(19) United States
(12) Patent Application Publication
(10) Pub. No.: US 2008/0048435 A1
(43) Pub. Date: Feb. 28, 2008

(54) Pipe coupling and clamp and method of application

(76) Inventor: Kelly G. Sabastian, Covington, KY (US)

Correspondence Address: Mark F. Smith, 905 Ohio Pike, Cincinnati, OH, 45245, US

(21) Appl. No.: 11/484,546

(22) Filed: Jul. 10, 2006

(51) Int. Cl. F16L 55/18

(52) U.S. Cl. 285/15

(57) ABSTRACT

A pipe coupling and clamp effective for attaching to pipes for repairing clogs and/or leaks, that can be used for connecting pipes together, that has a relatively low profile, is relatively easy to install, that is relatively inexpensive to manufacture, and which can be used with a variety of pipes.

### BACKGROUND OF THE INVENTION

The present invention is directed to pipes and more particularly, to a pipe coupling and clamp and method for attaching the pipe coupling and clamp to pipes for repairing leaks or for connecting pipes together.

Plastic pipe systems formed from polyvinyl chloride, chlorinated polyvinyl chloride, polyethylene and other plastic materials are widely used for a variety of applications. Pipe systems commonly use a string of individual lengths of pipes which are connected together using couplings. Such couplings are often integral to the pipe, such as in the form of a bell end, or are separate pieces often forming a “T”, or a “Y” or other similar coupling. Occasionally, piping systems must be modified after placement to connect to other piping systems such as by use of a “T” or a “Y” coupling. Frequently this is accomplished by cutting out a portion of the pipe and inserting a coupling. Unfortunately, this method is often time consuming and requires the pipe to be cut in two places that may result in future leaks.

After time, pipes may acquire leaks that are the result of deterioration of the material forming the pipe. Leaks may also develop that are the result of physical damage, such as for example the result of construction whereby a nail or a screw accidentally penetrates the wall of a pipe. Clamps have been developed for repairing pipes that have developed small leaks or are physically damaged. Typically, the clamps are attached to a pipe by placing a gasket around the pipe and are secured in place, such as by metallic bands which encircle the pipe and tighten to maintain the gasket in place. Many of the clamps include means that may be used to provide pressure forcing the gasket against the outer surface of the pipe to reduce the possibility of leakage around the clamp.

In certain applications, pipes may become clogged. Depending on the cause of the clog, chemicals can be used or a rotor system can be inserted into the pipe to cut and break apart the substance forming the clog. Unfortunately, the use of chemicals is not always permitted depending on the use of the pipe system and frequently do not operate to eliminate the clog. Rotor systems may also be undesirable as they are not always practicable and may even result in damage to the pipe causing leaks. Further, depending on the location of the clog, a rotor system may not be effective. Accordingly, it is often desirable to drill a hole into a pipe at the location of the clog and remove the clogging material through the hole.

One problem common to repairing and modifying pipes is that the location of the pipe is frequently in a hard to reach area or requires a relatively low profile clamping or coupling means to avoid interference with other pipes or structures in the immediate vicinity. Further, pipes are frequently located immediately adjacent to other structures such that clamping or coupling means that encircle the pipe are difficult to install or impractical.

Accordingly, it would be desirable for a pipe coupling and clamp that is effective for attaching to pipes for repairing clogs and/or leaks, that can be used for connecting pipes together, that has a relatively low profile, is relatively easy to install, that is relatively inexpensive to manufacture, and which can be used with a variety of pipes.

### SUMMARY OF THE INVENTION

A pipe coupling and clamp for a pipe having an outer surface, the pipe coupling and clamp comprising a partial annular plate having a concave inner surface and first and second semi-flexible plate edges; wherein the inner surface is complementary with the outer surface of the pipe and sized such that it has a radius of curvature slightly larger than the radius of curvature of the outer surface of the pipe so that when attached to the pipe the partial annular plate forms a snug fit over the outer surface of the pipe.

In another preferred embodiment of the invention the pipe coupling and clamp is formed from the same material as the pipe.

In another preferred embodiment of the invention the first and second plate edges are flexible enough to permit said edges to radially flex and allow the pipe coupling and clamp to be placed over the outside surface of the pipe.

In another preferred embodiment of the invention the pipe coupling and clamp further comprises a sealant along the inner surface of the partial annular plate to form a gasket between the inner surface of the pipe coupling and clamp and the outer surface of the pipe for preventing fluid leakage around the pipe coupling and clamp.

In another preferred embodiment of the invention the pipe coupling and clamp further comprises a male connector for coupling a first pipe to a second pipe.

In another preferred embodiment of the invention the pipe coupling and clamp comprises a male connector in flow communication with the pipe and includes a removable end cap.

Other aspects, advantages and embodiments of the invention will be apparent from the following description and the appended claims.

### BRIEF DESCRIPTION OF THE DRAWINGS

These and other features, aspects, and advantages of the present invention will become better understood with regard to the following description, appended claims, and accompanying drawings where:

FIG. 1 is an exploded perspective view showing a portion of a pipe system having a portion of a pipe with a crack forming an aperture whereby fluid can leak out of said pipe and the pipe coupling and clamp of the subject invention having a semi-annular plate effective for being placed onto to the outer surface of the pipe to cover and seal the crack to prevent leakage of fluid;

FIG. 2 is a perspective view of the pipe coupling and clamp of FIG. 1 fully attached to the pipe;

FIG. 3 is a perspective view showing the pipe coupling and clamp having plate edges that flex radially outwardly to allow the pipe coupling and clamp to fit over the outer surface of the pipe and “snap” into a secure position;

FIG. 4 is a perspective view of the pipe coupling and clamp of the present invention having a portion of the pipe coupling and clamp cut-out to show a sealing material positioned between the outer surface of the pipe and the inner surface of the pipe coupling and clamp to form a gasket to prevent leakage around the pipe coupling and clamp;

FIG. 5 is a side view of another preferred embodiment of the invention illustrating the inner surface of the annular plate having a sealant and a release paper thereon;

FIG. 6 is a perspective view of another preferred embodiment of the pipe coupling and clamp which is effective for attaching to a pipe and includes a cylindrical male connector having smooth inner and outer surface for telescopically attaching to a branch pipe or for receiving an end cap as shown;

FIG. 7 is a perspective view of another preferred embodiment of the pipe coupling and clamp which is effective for attaching to a pipe and includes a cylindrical male connector having internal threads for attaching to a branch pipe having corresponding external threads;

FIG. 8 is a perspective exploded view of the pipe coupling and clamp of FIG. 7 showing the male connector attached to a branch pipe or end cap, as shown;

FIG. 9 is a perspective view of another preferred embodiment of the pipe coupling and clamp which is effective for attaching to a branch pipe and includes a cylindrical male connector having outer threads for attaching to the branch pipe;

FIG. 10 is a perspective view of the pipe coupling and clamp of FIG. 9 showing a cylindrical male connector attached to an end cap; and

FIG. 11 is a schematic diagram illustrating the methodology of applying a pipe coupling and clamp along the surface of a pipe.

### DETAILED DESCRIPTION OF THE INVENTION

The present invention is directed to pipes and more particularly, to a pipe coupling and clamp and method for attaching the pipe coupling and clamp to pipes for repairing or for connecting pipes together. Although specific embodiments of the invention will now be described with reference to the drawings, it should be understood that such embodiments are by way of example only and merely illustrative of but a small number of the many possible specific embodiments which can represent applications of the principles of the invention. Various changes and modifications obvious to one skilled in the art to which the invention pertains are deemed to be within the spirit, scope and contemplation of the invention as further defined in the appended claims.

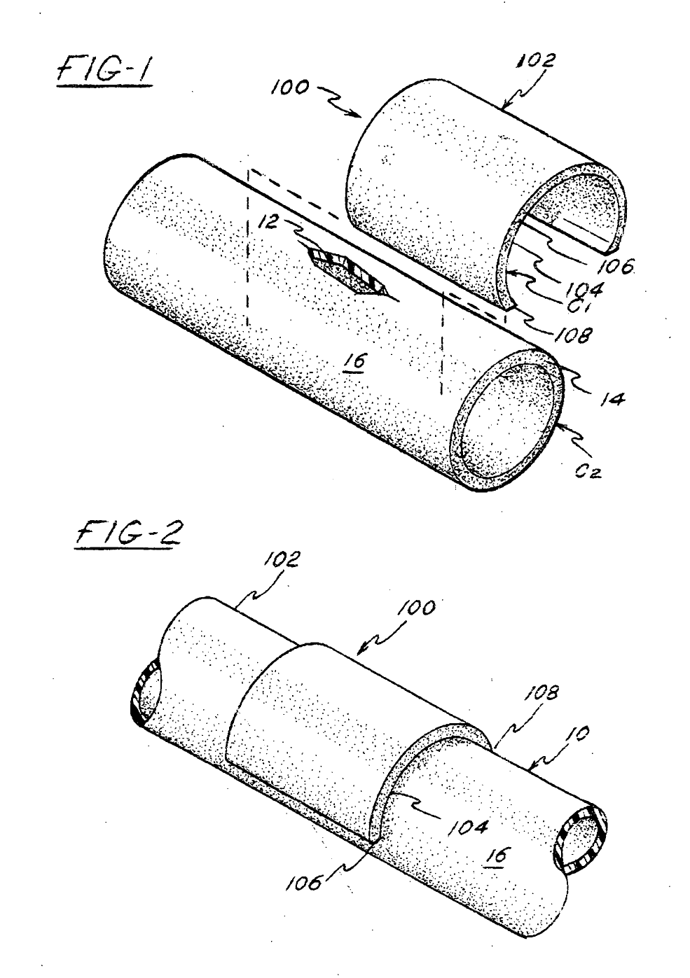

Referring to FIGS. 1 and 2, a section of a pipe 10 of a typical pipe system is shown illustrating a pipe 10 having an aperture 12 extending through the wall 14 of the pipe 10. The aperture 12 typically is formed from deterioration of the pipe forming a crack or a hole or it can be created by physical damage, such as by a construction nail or screw penetrating the wall of the pipe. As shown, the pipe 10 is a tubular conduit formed from polyvinyl chloride commonly used for pipes for homes, buildings and other similar structures. It should be understood, however, that the subject invention can be used with pipes formed from other materials, including but not limited to other plastics, including but not limited to chlorinated polyvinyl chloride, or polyethylene; or various metals, including but not limited to copper and aluminum. As shown, the wall 14 of the pipe 10 has a smooth, convex outer surface 16.

A preferred embodiment of the pipe coupling and clamp 100 of the subject invention is shown comprising a partial annular plate 102 having a concave inner surface 104 with first and second semi-flexible plate edges 106 and 108, respectively. The inner surface 104 is complimentary with the outer surface 16 of the pipe 10 and is sized such that its radius of curvature C1 (FIG. 5) is slightly larger than the radius of curvature C2 (FIG. 5) of the outer surface 16 of pipe 10 such that when it is attached to pipe 10 it forms a snug fit over the outer surface 16. It should also be understood that the longitudinal length and the circumferential width of the plate 102 is sufficient to cover the aperture 12 forming the area of the leakage.

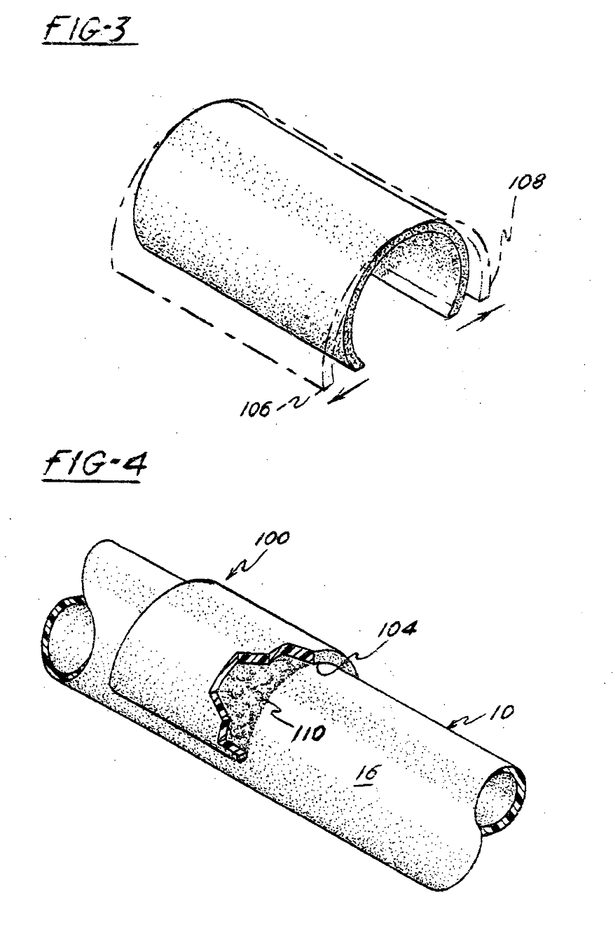

Referring to FIGS. 1 and 2, the pipe coupling and clamp 100 is shown installed around pipe 10. As shown in FIG. 3, plate 102 is flexible enough to allow first and second plate edges 106 and 108 to flex radially outwardly away from each other thereby allowing the plate edges to slide along the outer surface 16 of the pipe 10 until the pipe coupling and clamp 100 “snaps” into position such that the plate edges 106, 108 are in their non-flex condition and the inner surface 104 of the plate 102 seats snugly against opposing outer surface 16 of pipe 10 thereby sealing aperture 12 and preventing leakage there from. It should be understood that the flexibility of first and second plate edges 106 and 108 permits the radius of curvature C1 of inner surface 104 of plate 102 to nearly match the radius of curvature C2 of the outer surface 16 of pipe 10 thus providing the pipe coupling and clamp a snug fit.

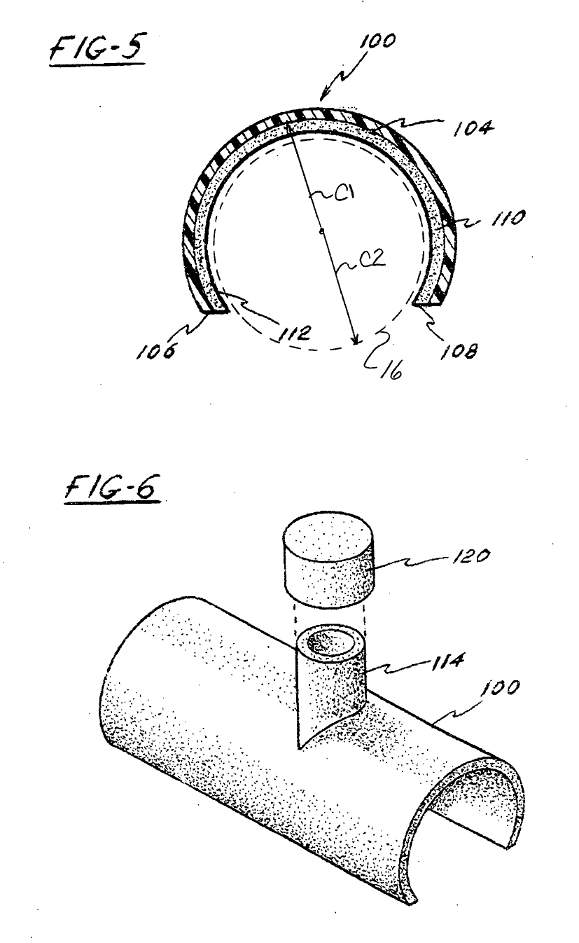

In another preferred embodiment of the invention, as shown in FIG. 4 the pipe coupling and clamp 100 is provided with a suitable sealant 110 that cooperates with the inner surface 104 of annular plate 102 and the outer surface 16 of the pipe 10 to form a gasket or seal between the pipe coupling and clamp 100 and the pipe 10. It should be understood that suitable sealants may include adhesives, glues and other materials typically used in the piping industry to permanently attach pipes together and/or prevent leakage. It should also be understood that the sealant 110 can be applied along the inner surface 104 of annular plate 102 at the time of installation or can be applied to the inner surface 104 and covered with a release paper 112 as illustrated in FIG. 5. In use, the user prior to flexing the plate edges 106, 108 removes the release paper 112 to expose the sealant 110. The pipe coupling and clamp 100 can then be attached to the pipe 10 by simply flexing the plate edges 106, 108 radially outwardly allowing the pipe coupling and clamp 100 to snap into place on the pipe 10. It should now be understood by those skilled in the art that the sealant 110 together with the tight clamp created by the plate edges 106, 108 creates a tight seal to prevent fluid leakage.

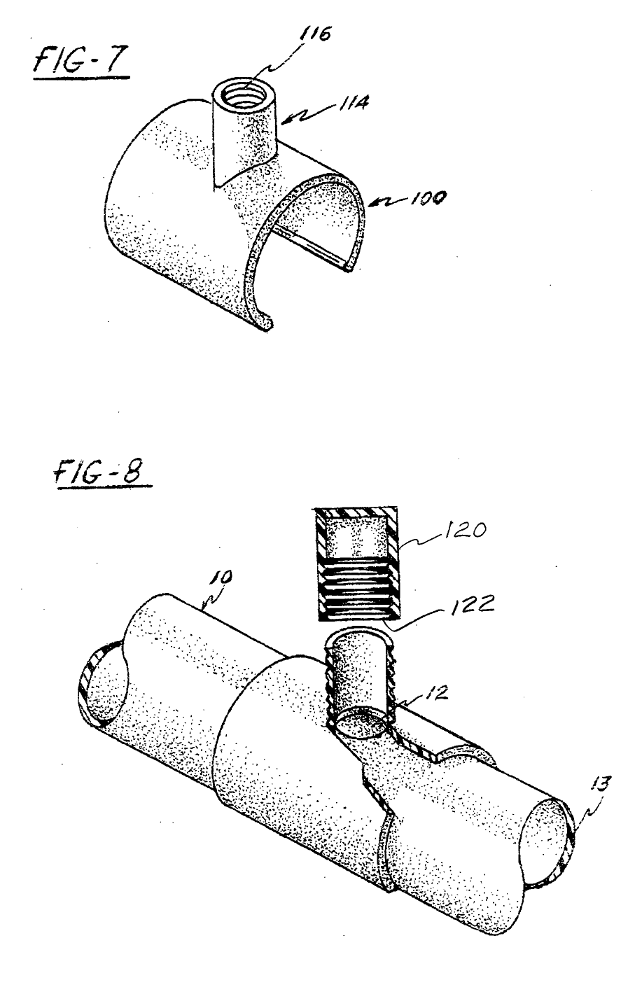

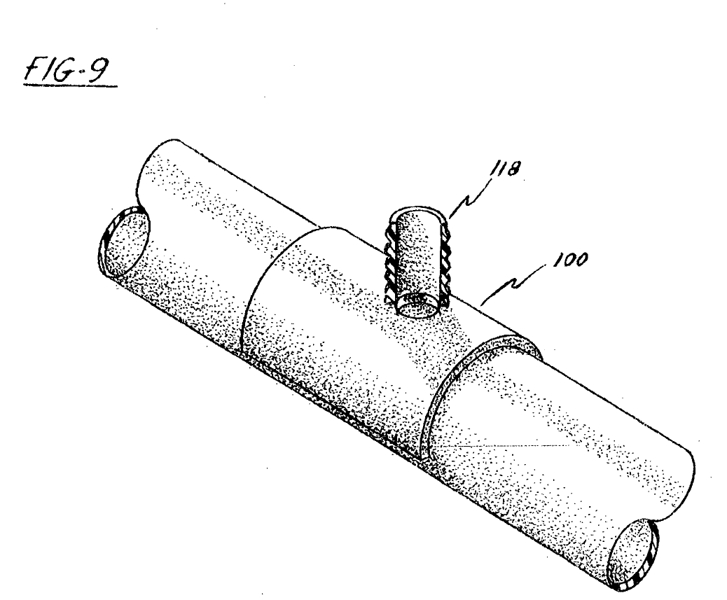

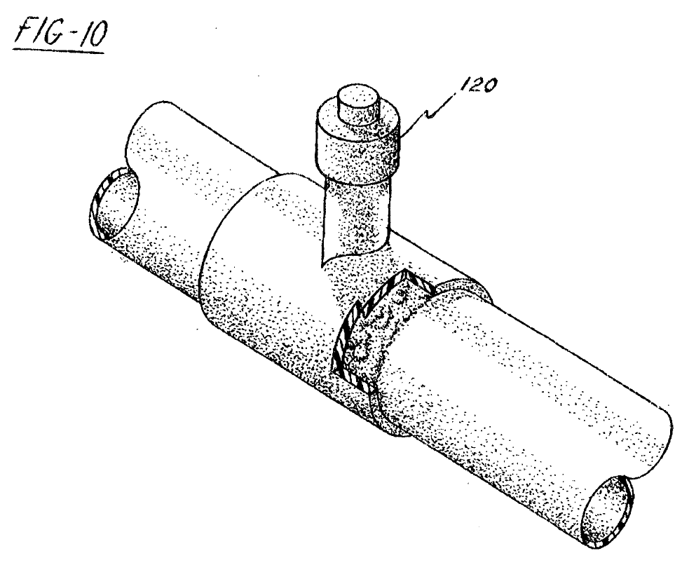

Another preferred embodiment of the invention is shown in FIGS. 6, 7 and 8. The pipe 10 is provided with an aperture 12 that is placed through the pipe wall 13 such as by use of a drill. The pipe coupling and clamp 100 is provided with a cylindrical male connector 114. In operation, the cylindrical male connector 114 is positioned such that it is in flow communication with fluid flowing in the pipe 10. The male connector 114 may have smooth inner and outer walls, as shown in FIG. 6 that cooperate with a branch pipe to telescopically fit together to form a snug fit. The male connector 114 may also have inner threads 116, as shown in FIG. 7, that connects with a branch pipe or plug having corresponding outer threads that cooperate together to form a secure fit. The male connector 114 may also have external threads 118, as shown in FIGS. 8, 9 and 10, that connects with a branch pipe or plug 120 having corresponding inner threads 122 that cooperate together to form a secure fit. It should also be understood that a sealant may be used to form a gasket that ensures a seal to prevent leakage of fluid. It should also be understood that the pipe coupling and clamp 100 having a removable plug or end cap 120 can be placed at various positions along a pipe system to allow for easy removal of material that may from time-to-time clog the pipe.

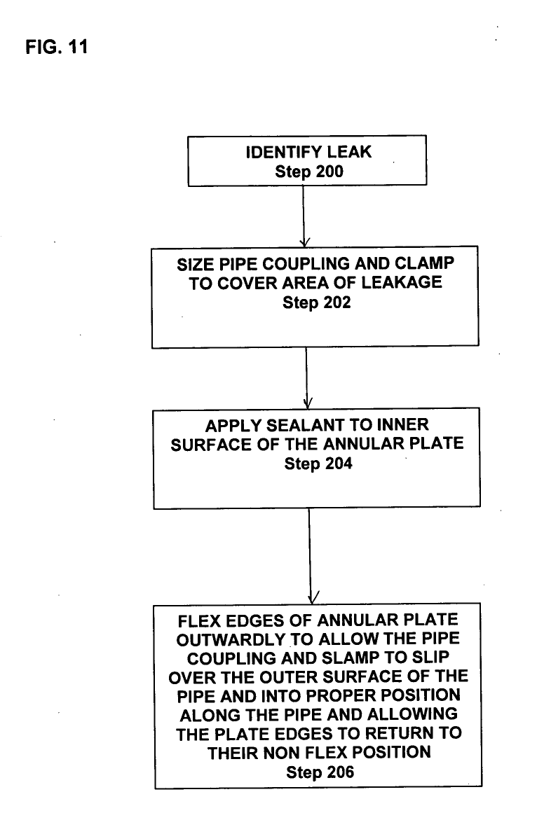

Referring to FIG. 11 is the methodology of attaching the pipe coupling and clamp of the subject application to a pipe. For repairing a leak, the aperture causing the leak is first identified, step 200. A pipe connector and clamp is then selected such that the partial annular plate forming the pipe coupling and clamp is sized such that it will completely cover the area of leakage, step 202. A sealant is then applied to the inner surface of the annular plate, step 204, to form a fluid tight gasket and the plate edges are flexed outwardly to allow the pipe coupling and clamp to slip over the outer surface of the pipe and into proper position along the pipe, step 206.

It should now be seen that the pipe coupling and clamp of the subject invention is effective for attaching to pipes for repairing clogs and/or leaks, can be used for connecting pipes together, has a relatively low profile, is relatively easy to install, is relatively inexpensive to manufacture, and can be used with a variety of pipes. It should also now be apparent to those skilled in the art that the pipe coupling and clamp of the present invention can be formed from a single piece thereby making it easy to install along a section of a pipe. Further, the pipe coupling and clamp only covers a portion of the pipe circumference thereby making it suitable for pipes that are in difficult to reach locations or are abutting other structures.

Although the foregoing invention has been described in some detail for purposes of clarity of understanding, it will be apparent that certain changes and modifications may be practiced within the scope of the appended claims. Furthermore, it should be noted that there are alternative ways of implementing both the article and method of the present invention. Accordingly, the present embodiments and examples are to be considered as illustrative and not restrictive, and the invention is not to be limited to the details given herein, but may be modified within the scope and equivalents of the appended claims.

I claim:

1. A pipe coupling and clamp for a pipe having an outer surface, the pipe coupling and clamp comprising:
a partial annular plate having a concave inner surface and first and second semi-flexible plate edges;
wherein said inner surface is sized and has a radius of curvature slightly larger than the radius of curvature of the outer surface of the pipe such that when attached to the pipe said partial annular plate forms a snug fit over the outer surface of the pipe; and
wherein said semi-flexible edges are effective for radially flexing outwardly to permit the partial annular plate to slide into position along a portion of the pipe.

2. The pipe connector and clamp of claim 1 wherein said pipe coupling and clamp is formed from the same material as the pipe.

3. The pipe connector and clamp is formed from a plastic material.

4. The pipe connector and clamp of claim 1 further comprising a sealant along the inner surface of said partial annular plate effective for forming a gasket to prevent leakage of fluid.

5. The pipe coupling and clamp of claim 1 further comprising a male connector for connecting a first pipe to a second pipe.

6. The pipe connector and clamp of claim 1 further comprising a male connector in flow communication with the pipe and having a removable end cap.

7. A pipe coupling and clamp for a pipe having an outer surface, the pipe coupling and clamp comprising:
a partial annular plate having a concave inner surface, first and second semi-flexible plate edges and means for coupling the pipe to another pipe;
wherein said flexible plate edges flex radially outwardly for placing the pipe coupling and clamp around the outside surface of the pipe; and
wherein said inner surface is sized and has a radius of curvature slightly larger than the radius of curvature of the outer surface of the pipe such that when attached to the pipe said partial annular plate forms a snug fit over the outer surface of the pipe.

8. The pipe coupling and clamp of claim 7 wherein said pipe coupling and clamp is formed from the same material as the pipe.

9. The pipe coupling and clamp of claim 7 further comprising a sealant along the inner surface of said partial annular plate.

10. The pipe coupling and clamp of claim 7 wherein said means for coupling the pipe to another pipe comprises a male connector for connecting a first pipe to a second pipe.

11. The pipe coupling and clamp of claim 7 further comprising a male connector in flow communication with the pipe and having a removable end cap.

12. The pipe coupling and clamp of claim 7 wherein said pipe coupling and clamp is formed from plastic.

13. A method of repairing a leak in a pipe comprising the steps of:
identifying the location of the leak;
selecting a pipe connector and clamp having a partial annular plate sized to cover the area of the leak;
applying a sealant to the inner surface of the annular plate;
flexing the edges of the partial annular plate such that the partial annular plate slips over the outer surface of the pipe and effectively covers the area of the leak.
